(19) United States
(12) Patent Application Publication
(10) Pub. No.: US 2022/0005172 A1
(43) Pub. Date: Jan. 6, 2022

(54) WORK DETERMINATION SYSTEM, WORK DETERMINATION APPARATUS, AND WORK DETERMINATION METHOD

(71) Applicant: SONY GROUP CORPORATION, TOKYO (JP)

(72) Inventors: KENICHI KATAGAI, TOKYO (JP); MIKI GOTOU, TOKYO (JP)

(21) Appl. No.: 17/293,122

(22) PCT Filed: Nov. 20, 2019
(86) PCT No.: PCT/JP2019/045450

§ 371 Date: May 12, 2021

(30) Foreign Application Priority Data
Nov. 21, 2018 (JP) 2018-218139

(51) Int. Cl. G06T 7/00; G06Q 10/08; G02F 1/1337

(52) U.S. Cl. CPC G06T 7/001; G02F 1/133788; G06Q 10/087

(57) ABSTRACT

A work determination system that can improve work determination accuracy is to be provided. The work determination system includes a polarized camera that images a work and a work determination apparatus, in which the work determination apparatus includes: a reference image acquisition unit that acquires a reference image of the work imaged by the polarized camera; a determination model construction unit that constructs a determination model for determining the work by machine learning using the reference image; and a determination unit that determines a work to be determined by using the reference image of the work to be determined and the determination model constructed in advance.

### TECHNICAL FIELD

The present technology relates to a work determination system, a work determination apparatus, and a work determination method.

### BACKGROUND ART

Works such as AC cables, AC adapters, remote controls, and battery chargers that come with set products such as home appliances and game machines often have different shapes depending on the destination. Thus when a product is packaged, in order to prevent the occurrence of a defective product, a visual check is performed to see whether or not a work having a shape not corresponding to the destination of the product (work for a different destination) is attached by mistake. However, human error can occur, and it is difficult to completely prevent the occurrence of “misplacement” in which a work for a different destination is mixed in the product.

For example, Patent Document 1 describes a technology related to a work determination apparatus, but it is difficult to ensure a determination accuracy that can meet the practical use. For this reason, there is a reality that at a manufacturing site of the product, the visual check has to be performed to detect the misplacement of the work.

### CITATION LIST

### Patent Document

Patent Document 1: Japanese Patent Application Laid-Open No. H10-180669

### SUMMARY OF THE INVENTION

### Problems to be Solved by the Invention

In order to prevent the occurrence of misplacement of a work, a technology for automatically and highly accurately determining a work is required. Therefore, a main object of the present technology is to provide a work determination system that can improve work determination accuracy.

### Solutions to Problems

That is, the present technology provides a work determination system including a polarized camera that images a work and a work determination apparatus, in which

the work determination apparatus includes:

a reference image acquisition unit that acquires a reference image of the work imaged by the polarized camera;

a determination model construction unit that constructs a determination model for determining the work by machine learning using the reference image; and

a determination unit that determines a work to be determined by using the reference image of the work to be determined and the determination model constructed in advance.

The work determination apparatus may include a worked image generation unit that generates a worked image on the basis of the reference image, the determination model construction unit may further use the worked image in the machine learning, and the determination unit may further use the worked image at the time of determining the work to be determined.

The worked image may be at least one type of image selected from a reflection-removed image, a degree-of-polarization image, or a normal-direction image.

The determination model construction unit may further use information on a destination of the work in the machine learning, and the determination unit may determine whether or not the work to be determined is a work corresponding to a predetermined destination.

The work determination system may include a ring-shaped light source that irradiates the work imaged by the polarized camera with light.

The work imaged by the polarized camera may be placed on a sheet, and a light reflectance of the sheet may be lower than a light reflectance of the work.

The work determination system may include a rolling force transmission unit that rolls the work imaged by the polarized camera.

The work determination system may include a weight measurement unit that measures weight of the work to be determined, and the work determination apparatus may include a defective product detection unit that detects a defective work on the basis of the weight measured by the weight measurement unit.

The present technology further provides

a work determination apparatus including:

a reference image acquisition unit that acquires a reference image of a work imaged by a polarized camera;

a determination model construction unit that constructs a determination model for determining the work by machine learning using the reference image; and

a determination unit that determines a work to be determined by using the reference image of the work to be determined and the determination model constructed in advance.

The present technology further provides

a work determination method including:

a step of acquiring a reference image of a work imaged by a polarized camera;

a step of constructing a determination model for determining the work by machine learning using the reference image; and

a step of determining a work to be determined by using the reference image of the work to be determined and the determination model constructed in advance.

### BRIEF DESCRIPTION OF DRAWINGS

FIG. 1 is a schematic diagram illustrating an example of a configuration of a work determination system 1

FIG. 2 is a diagram illustrating an example of a polarizer.

FIG. 3 is a block diagram illustrating an example of a functional configuration of a work determination apparatus 20.

FIG. 4 is a graph illustrating an example of a fitting result to a model function.

FIG. 5 is a graph illustrating an example of a fitting result to a model function.

FIG. 6 is an example of a graph representing a relationship between an inclination of a work surface and a P-S separation ratio.

FIG. 7 is a reference diagram for explaining a normal-direction image.

FIG. 8 is a flowchart illustrating an example of processing related to machine learning.

FIG. 9 is a flowchart illustrating an example of processing that determines a work.

FIG. 10 is a schematic diagram illustrating an example of a sheet.

FIG. 11 is a diagram illustrating an example of images used in first to fourth tests.

FIG. 12 is a diagram illustrating an example of images used in fifth to seventh tests.

### MODE FOR CARRYING OUT THE INVENTION

Modes suitable for carrying out the present technology will now be described with reference to the drawings. Note that the embodiments described below illustrate typical embodiments of the present technology, by which the scope of the present technology is not to be narrowly interpreted. The description will be made in the following order.

### 1. First Embodiment

(1) Overall configuration of work determination system

(2) Functional configuration of work determination apparatus

(3) Operation of work determination system

2. First modification of first embodiment (configuration including ring-shaped light source)

3. Second modification of first embodiment (configuration in which work is placed on sheet)

4. Second embodiment (configuration including rolling force transmission unit)

5. Third embodiment (configuration including weight measurement unit)

### 1. First Embodiment

(1) Overall Configuration of Work Determination System

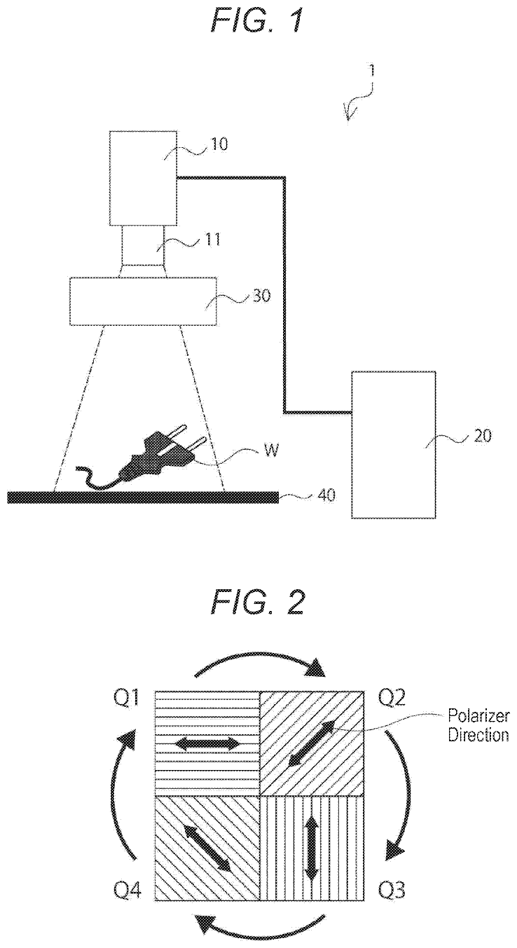

An overall configuration of a work determination system 1 according to a first embodiment will be described with reference to FIG. 1.

FIG. 1 is a schematic diagram illustrating an example of a configuration of the work determination system 1 according to the present technology. As illustrated in FIG. 1, the work determination system 1 includes a polarized camera 10 that includes a lens 11 and images a work W, and a work determination apparatus 20.

The work W is not limited to a particular one and includes, for example, various members, parts, accessories, or the like attached to a set product such as a home appliance or a game machine, and specifically includes an AC cable, an AC adapter, a remote control, a battery charger, or the like.

The polarized camera 10 is a camera that images the work W and acquires polarization information of the work W. The polarized camera 10 is not limited to a particular one, and, for example, a polarized camera with polarizers in four directions as illustrated in FIG. 2 can be used, the polarizers being arranged while being rotated 45 degrees each on each pixel of an image sensor.

The work determination apparatus 20 is a computer including hardware such as a central processing unit (CPU), a read only memory (ROM), a random access memory (RAM), a hard disk drive (HDD), or the like. A personal computer (PC) is used as the work determination apparatus 20, for example, but any other computer may be used thereas. Each function of the work determination apparatus 20 described later is implemented when the CPU calls a program or data recorded in the ROM, the HDD, or the like on the RAM and executes processing.

In the example illustrated in FIG. 1, the work determination apparatus 20 is connected to the polarized camera 10 by wire. The work determination apparatus 20 acquires an image of the work W imaged by the polarized camera 10 and uses the image for various processings. The connection between the work determination apparatus 20 and the polarized camera 10 is not limited to the wired connection described above, and may be established by a wireless local area network (LAN) or the like.

(2) Functional Configuration of Work Determination Apparatus

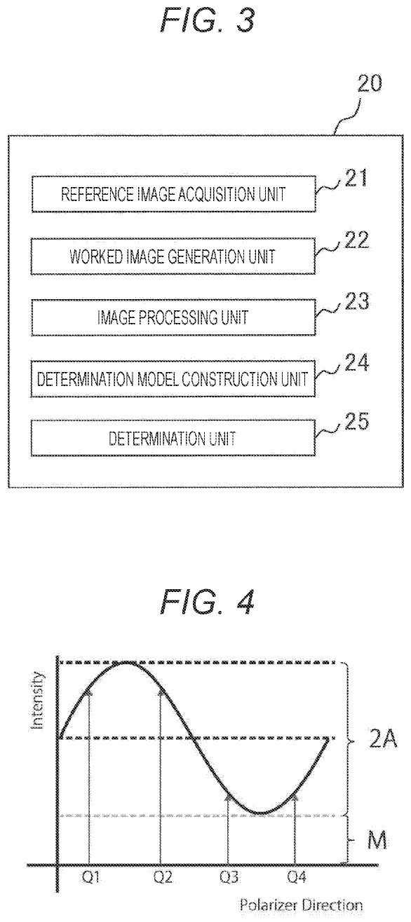

Next, a functional configuration of the work determination apparatus 20 will be described with reference to FIG. 3. FIG. 3 is a block diagram illustrating an example of the functional configuration of the work determination apparatus 20. The work determination apparatus 20 can include, as functional units, a reference image acquisition unit 21, a worked image generation unit 22, an image processing unit 23, a determination model construction unit 24, and a determination unit 25. The worked image generation unit 22 and the image processing unit 23 are not essential functional units, and the work determination apparatus 20 may include only the reference image acquisition unit 21, the determination model construction unit 24, and the determination unit 25.

(2-1) Reference Image Acquisition Unit 21

The reference image acquisition unit 21 acquires a reference image of a work imaged by the polarized camera 10. The reference image includes polarization information of the work. The reference image is used as image data for machine learning in the determination model construction unit 24. The reference image is also used as image data for determining the work in the determination unit 25.

(2-2) Worked Image Acquisition Unit 22

The worked image generation unit 22 generates a worked image on the basis of the reference image acquired by the reference image acquisition unit 21. The worked image is used as image data for machine learning together with the reference image in the determination model construction unit 24. The worked image is also used as image data for determining the work together with the reference image in the determination unit 25.

The worked image is preferably at least one type of image selected from a reflection-removed image, a degree-of-polarization image, or a normal-direction image, more preferably at least two types of images selected from the reflection-removed image, the degree-of-polarization image, or the normal-direction image, still more preferably the reflection-removed image, the degree-of-polarization image, and the normal-direction image.

The reflection-removed image is an image in which a diffuse reflection component is removed from the reference image. A known technique can be used to generate the reflection-removed image. For example, an image assumed in a case where a crossed Nicol state is created for each pixel can be generated as the reflection-removed image. Specifically, the reflection-removed image can be obtained by calculating minimum intensity “M” assumed from a fitting result for a model function indicated by the following expression (1) for each pixel, and making an image thereof.

Iₘ=A·(1+cos(2·(π/4·m+φ))))+M (1)

(In the above expression (1), “m” indicates a direction of the polarizer, and m=1, 2, 3, or 4. Moreover, “Iₘ” indicates light receiving intensity, “A” indicates a variable component, “M” indicates a fixed component, and “φ” indicates a phase of the variable component.)

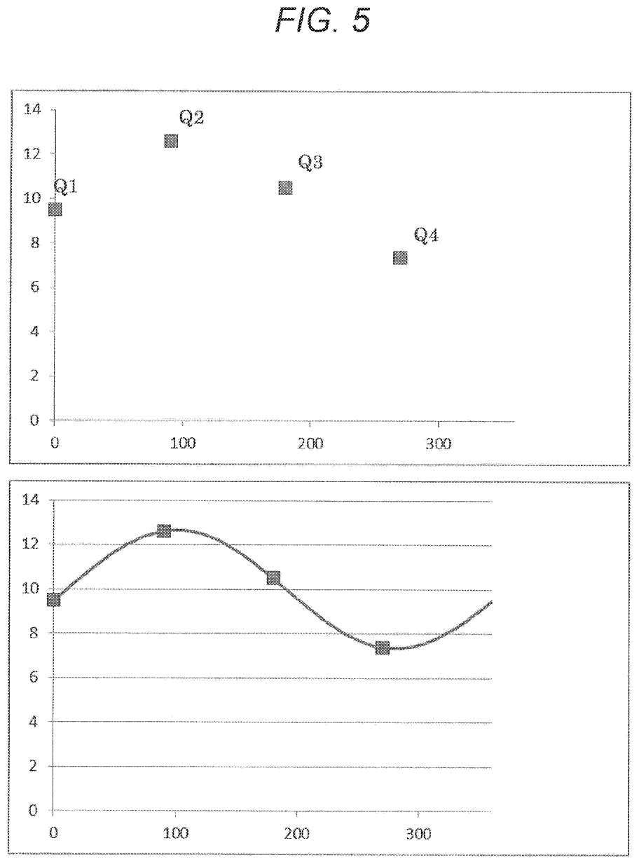

FIG. 4 illustrates an example of the fitting result to the above model function.

The degree-of-polarization image is an image displaying a degree of polarization of the reference image. Specifically, the degree-of-polarization image is a black-and-white image of black (degree of polarization=0) to white (degree of polarization=1) corresponding to the degree of polarization having the range of zero to one. A known technique can be used to generate the degree-of-polarization image. For example, the light receiving intensity is modeled using the above expression (1), and fitting is performed from four results of fixed angles of rotation of zero degree, 45 degrees, 90 degrees, and 135 degrees. Moreover, the degree of polarization (DoP) can be calculated by using the following expression (2).

Degree of polarization (DoP)=(Iₘₐₓ−Iₘᵢₙ)/(Iₘₐₓ+Iᵢₙ)=2A/(2A+2M) (2)

(In the above expression (2), “Iₘₐₓ” indicates a maximum value of the light receiving intensity, “Iₘᵢₙ” indicates a minimum value of the light receiving intensity, “A” indicates a variable component, and “M” indicates a fixed component.)

FIG. 5 illustrates an example of the above fitting result.

The degree of polarization takes the value of zero to one as described above. In a case of linearly polarized light, the degree of polarization is one since M=0 in the above expression (2). In a case of unpolarized light, the degree of polarization is zero since A=0 in the above expression (2).

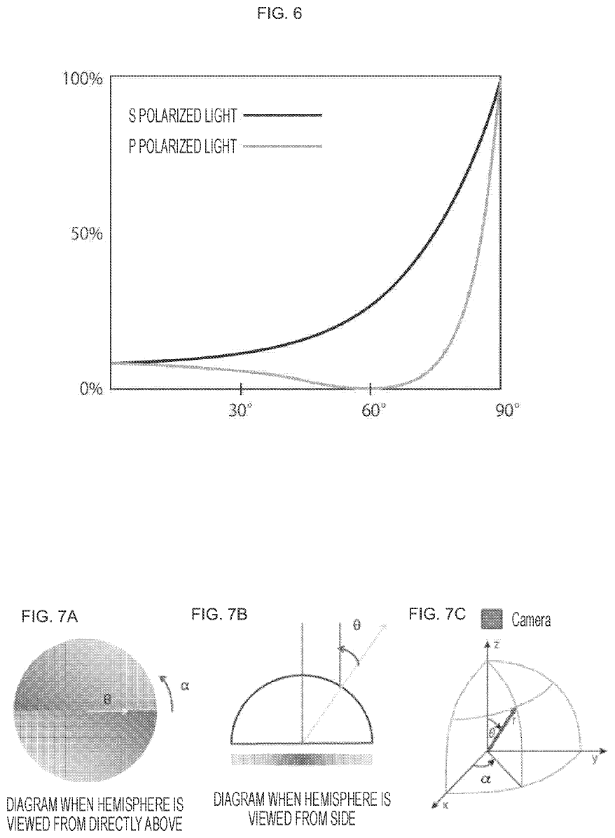

The normal-direction image is an image in which a normal direction of the reference image is displayed in a color space. That is, the normal-direction image is a color image that is colored according to an azimuth angle α and a zenith angle θ of the normal direction. A known technique can be used to generate the normal-direction image. For example, a polarization ratio variation (P-S separation) of reflected light of the reference image is measured and converted into an inclination of a work surface. FIG. 6 illustrates an example of a graph representing a relationship between the inclination of the work surface and the P-S separation ratio.

The azimuth angle α of the normal direction can be obtained by, for example, the following expression (3) using the above expression (1). The zenith angle θ of the normal direction can be obtained by, for example, the following expression (4) using the above expression (2).

Azimuth angle α=polarization angle at Iₘᵢₙ=(initial phase φ+270 degrees)/2 (3)

Zenith angle θ=f(DoP)=f((Iₘₐₓ−Iₘᵢₙ)/(Iₘₐₓ+Iₘᵢₙ) (4)

The color space in the normal-direction image can be expressed by the RGB color system, and RGB values can be obtained by the following expressions (5) to (7).

R=cos α·sin θ (5)

G=sin α·sin θ (6)

B=cos θ (7)

FIG. 7 is a reference diagram for explaining the normal-direction image. FIG. 7A is an example of the normal-direction image in a case where a hemisphere is viewed from directly above. FIG. 7B is an example of the normal-direction image in a case where the hemisphere is viewed from the side. As illustrated in FIGS. 7A and 7B, the normal-direction image expresses a difference in the normal direction by a difference in color. FIG. 7C is a schematic diagram illustrating the azimuth angle α and the zenith angle θ of a normal direction

(2-3) Image Processing Unit 23

The image processing unit 23 processes the reference image and/or the worked image to generate a processed image. The processed image is used as image data for machine learning together with the reference image, or together with the reference image and the worked image in the determination model construction unit 24. The processed image is also used as image data for determining the work together with the reference image, or together with the reference image and the worked image in the determination unit 25. The image processing unit 23 thus plays a role of increasing the variation of the image data for machine learning and determination.

The processing in the image processing unit 23 is not particularly limited as long as the variation of the image data can be increased. For example, the processing includes processing of converting brightness (256 gradations) to a value between zero and one, processing of shifting the image up, down, left, or right within a predetermined pixel range (for example, a range of ±20 pixels), processing of tilting the image within a predetermined angle range (for example, a range of ±five degrees), processing of changing the image size, processing of changing the contrast, processing of regularizing the image (converting to mean=0 and standard deviation=1), or the like. The image processing unit 23 can generate various processed images by performing such various processings.

(2-4) Determination Model Construction Unit 24

The determination model construction unit 24 constructs a determination model for determining a work by machine learning using the reference image acquired by the reference image acquisition unit 21.

The determination model can be constructed by various techniques related to machine learning. For example, the determination model can be constructed by deep learning. Deep learning is a general term for machine learning using a multi-layer hierarchical neural network. The multi-layer neural network includes, for example, a convolutional neural network (CNN), a recurrent neural network (RNN), or the like.

The determination model construction unit 24 may further use the worked image generated by the worked image generation unit 22 in machine learning. That is, the determination model construction unit 24 may construct a determination model for determining a work by machine learning using the reference image and the worked image.

In a case where the determination model construction unit 24 uses the worked image for machine learning, the worked image is preferably at least one type of image selected from the reflection-removed image, the degree-of-polarization image, or the normal-direction image. The worked image above is more preferably at least two types of images selected from the reflection-removed image, the degree-of-polarization image, or the normal-direction image. The worked image is still more preferably the reflection-removed image, the degree-of-polarization image, and the normal-direction image. As the number of types of the worked image used for machine learning increases, the accuracy of machine learning can be improved so that the work determination accuracy in the determination unit 25 described later is improved.

Since the diffuse reflection of light from a work is suppressed in the reflection-removed image, it is considered that the original texture of the work is reflected in the reflection-removed image. It is presumed that by using the reflection-removed image in machine learning, a difference in the texture such as a difference in the material for each work can be learned.

Since extreme reflected light of a work due to illumination (such as the shine of a metal part or a cable part) is suppressed in the degree-of-polarization image, it is considered that the overall shape of the work is grasped more easily compared to an image captured by a normal camera that is not a polarized camera. It is presumed that by using the degree-of-polarization image in machine learning, a difference in the overall shape of the work (such as a winding state of a cable or a positional relationship between a plug and a cable) can be learned accurately.

In the normal-direction image, the condition of unevenness or a curve on the surface of a work is represented by color. It is presumed that by using the normal-direction image in machine learning, a difference in the surface shape of each work can be learned accurately.

The determination model construction unit 24 may further use the processed image generated by the image processing unit 23 in machine learning. That is, the determination model construction unit 24 may construct a determination model for determining a work by machine learning using the reference image, the worked image, and the processed image. By performing machine learning using the processed image in addition to the reference image and the worked image, the accuracy of machine learning is improved, and the work determination accuracy in the determination unit 25 described later is improved.

In machine learning, the image data used (the reference image, the worked image, and the processed image) may be given label data related to a work captured in the image, or the label data may be learned along with the image data. The label data can be input by a user via an input device (not shown) included in the work determination apparatus 20.

The determination model construction unit 24 may further use information on a destination of a work in machine learning. By learning the information on the destination of the work along with the image data, a characteristic of the work and the information on the destination thereof can be learned in association with each other. As a result, the determination unit 25 to be described later can determine whether or not a work to be determined is a work corresponding to a predetermined destination.

(2-5) Determination Unit 25

The determination unit 25 determines a work to be determined by using the reference image of the work to be determined and the determination model constructed in advance by the determination model construction unit 24.

In a case where the work determination apparatus 20 includes the worked image generation unit 22, and the determination model construction unit 24 constructs the determination model by machine learning using the reference image and the worked image, the determination unit 25 may further use the worked image at the time of determining the work to be determined. That is, the determination unit 25 may determine the work to be determined by using the reference image and the worked image of the work to be determined, and the determination model constructed in advance.

In a case where the work determination apparatus 20 includes the image processing unit 23, and the determination model construction unit 24 constructs the determination model by machine learning using the reference image, the worked image, and the processed image, the determination unit 25 may further use the processed image at the time of determining the work to be determined. That is, the determination unit 25 may determine the work to be determined by using the reference image, the worked image, and the processed image of the work to be determined, and the determination model constructed in advance.

In a case where the determination model construction unit 24 constructs the determination model by machine learning using the image data (the reference image, the worked image, and the processed image) and the information on the destination of the work, the determination unit 25 may determine whether or not the work to be determined is a work corresponding to a predetermined destination. This as a result can automate the detection of misplacement of a work, which has conventionally been performed by a visual check, so that the rate of occurrence of the misplacement of a work can be reduced significantly.

(3) Operation of Work Determination System

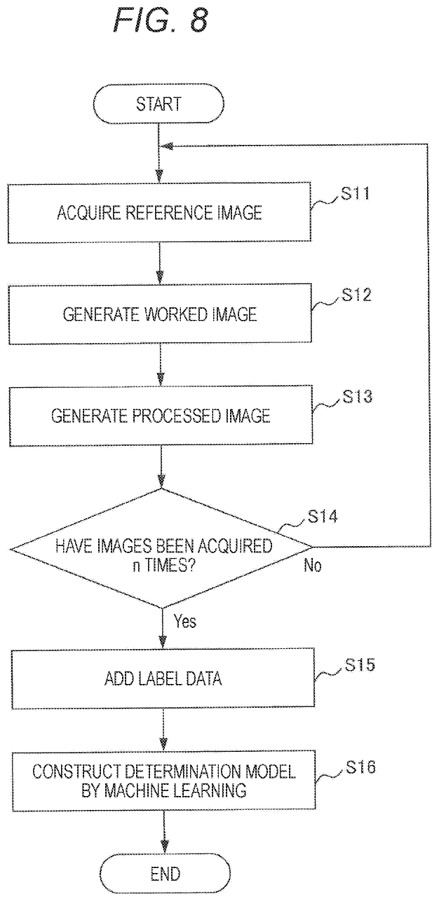

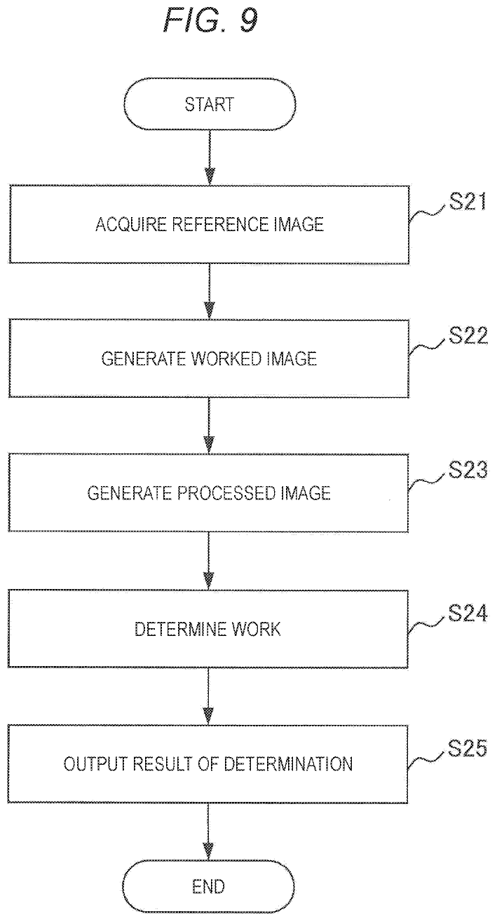

Next, the operation of the work determination system according to the first embodiment will be described with reference to FIGS. 8 and 9. A work determination method according to the present technology is implemented by the operation of the work determination system.

FIG. 8 is a flowchart illustrating an example of processing related to machine learning. The reference image acquisition unit 21 acquires a reference image of a work imaged by the polarized camera 10 (step S11). The worked image generation unit 22 generates a worked image on the basis of the reference image (step S12). The image processing unit 23 processes the reference image and the worked image to generate a processed image (step S13). If the number of times the images obtained through steps S11 to S13 have been acquired is less than a predetermined number (“n” times) (No in step S14), steps S11 to S13 are repeated. If the images have been acquired “n” times (Yes in step S14), label data related to the work input by a user is added to the reference image, the worked image, and the processed image (step S15). The determination model construction unit 24 constructs a determination model for determining the work by machine learning using the reference image, the worked image, the processed image, and information on the destination of the work (step S16).

The step of generating the worked image (step S12) and the step of generating the processed image (step S13) are not essential steps, but are preferably executed. This can increase the variation of the image data used for machine learning and further improve the accuracy of machine learning, so that the work determination accuracy is further improved.

The worked image generated in the step of generating a worked image (step S12) is preferably at least one type of image selected from the reflection-removed image, the degree-of-polarization image, or the normal-direction image. The worked image above is more preferably at least two types of images selected from the reflection-removed image, the degree-of-polarization image, or the normal-direction image. The worked image is still more preferably the reflection-removed image, the degree-of-polarization image, and the normal-direction image. These images are suitable for improving the work determination accuracy.

FIG. 9 is a flowchart illustrating an example of processing that determines a work. The reference image acquisition unit 21 acquires a reference image of a work to be determined that is imaged by the polarized camera 10 (step S21). The worked image generation unit 22 generates a worked image on the basis of the reference image (step S22). The image processing unit 23 processes the reference image and the worked image to generate a processed image (step S23). The determination unit 25 determines whether or not the work to be determined is a work corresponding to a predetermined destination by using the reference image, the worked image, and the processed image of the work to be determined and the determination model constructed in the processing of FIG. 8 described above (step S24). A result of the determination is output to, for example, a display unit (not shown) included in the work determination apparatus 20 or another device not shown (step S25).

The step of generating the worked image (step S22) and the step of generating the processed image (step S23) are not essential steps, but are preferably executed. This can further improve the work determination accuracy.

The type of the worked image generated in the step of generating a worked image (step S22) can be similar to the type of the worked image generated in step S12 illustrated in FIG. 8. Moreover, the type of the processed image generated in the step of generating a processed image (step S23) can be similar to the type of the processed image generated in step S13 illustrated in FIG. 8.

### 2. First Modification of First Embodiment

A first modification of the first embodiment will be described with reference to FIG. 1 again. The work determination system 1 according to the present modification includes, in addition to the configuration of the first embodiment described above, a ring-shaped light source 30 that irradiates a work imaged by the polarized camera with light. The ring-shaped light source 30 can reduce the influence of ambient light and also suppress diffuse reflection, so that it is possible to acquire an image that more accurately captures a difference in the shape, material, or the like of the work. The work determination accuracy can be further improved by performing machine learning using such an image.

As the ring-shaped light source 30, for example, a light source commercially available as a ring light can be used. The ring-shaped light source 30 is preferably disposed between a lens 11 of the polarized camera 10 and the work W.

### 3. Second Modification of First Embodiment

Next, a second modification of the first embodiment will be described with reference to FIG. 1. The work determination system 1 according to the present modification includes a sheet 40 in addition to the configuration of the first embodiment described above. The sheet 40 is disposed under the work W. That is, the work W is placed on the sheet 40.

The sheet 40 is preferably a sheet having a low light reflectance. Specifically, the light reflectance of the sheet 40 is preferably lower than the light reflectance of the work W. The sheet 40 disposed under the work W can reduce the reflected light. As a result, when an image of the work W is captured by the polarized camera 10, the image of the work W is brighter than an image of the surrounding background so that it is possible to acquire an image that captures a difference in the shape, material, or the like of the work W in more detail. The work determination accuracy can be further improved by performing machine learning using such an image.

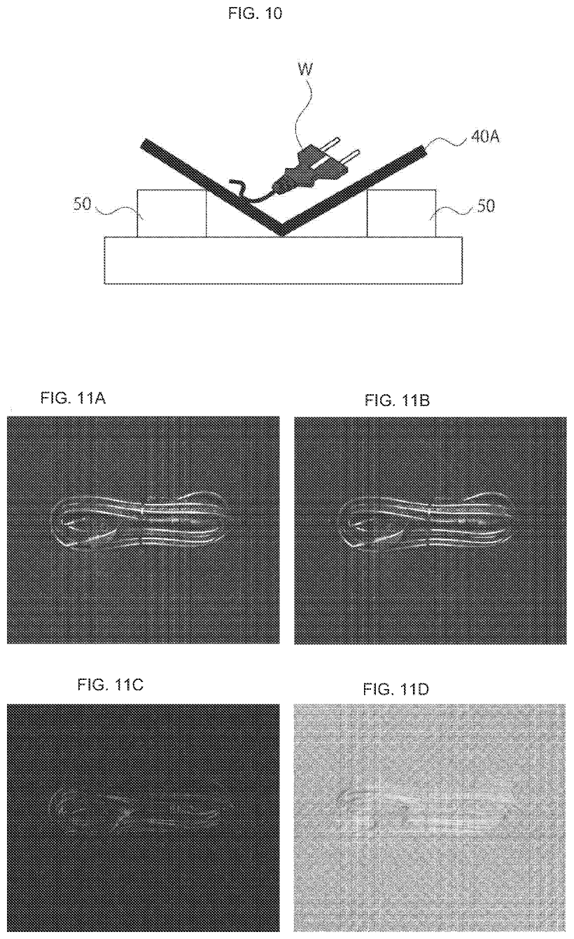

The shape of the sheet 40 may be flat as illustrated in FIG. 1, or another shape may be adopted as long as the effect of the present technology is not impaired. FIG. 10 is a schematic diagram illustrating an example of the sheet. For example, as illustrated in FIG. 10, a plate-shaped sheet 40A that is bent in a V shape when viewed from the side surface may be used. In this case, fixing members 50 and 50 may be arranged below the sheet 40A to fix the sheet 40A. The color of the sheet can be selected as appropriate, but is preferably black in terms of reducing the reflected light.

Note that the ring-shaped light source 30 of the first modification may be combined with the second modification of the first embodiment.

### 4. Second Embodiment

Next, a work determination system according to a second embodiment will be described. The work determination system of the present embodiment includes a rolling force transmission unit that rolls a work imaged by the polarized camera, in addition to the configuration of the first embodiment (including the first modification and the second modification).

In terms of improving the work determination accuracy, an image of the work imaged by the polarized camera preferably includes a characteristic part of the work. The characteristic part of the work is a part related to a difference between works that is used to distinguish the works from each other. In the present technology, if the position of the lens of the polarized camera is fixed, the characteristic part of the work may not be imaged in some cases depending on the orientation or angle of the work. In order to image the characteristic part of the work in such a case, it is preferable to change the orientation or angle of the work by applying a force to the work using the rolling force transmission unit and rolling the work. Rolling of the work enables acquisition of an image that more accurately captures the characteristic part of the work, and by performing machine learning using such an image, the work determination accuracy can be further improved.

### 5. Third Embodiment

Next, a work determination system according to a third embodiment will be described. The work determination system of the present embodiment includes a weight measurement unit that measures the weight of a work to be determined, in addition to the configuration of the first embodiment (including the first modification and the second modification). Furthermore, a work determination apparatus used in the work determination system of the present embodiment includes, as a functional unit, a defective product detection unit that detects a defective work on the basis of the weight measured by the weight measurement unit.

The structure or type of the weight measurement unit is not particularly limited as long as the weight of the work can be measured, and, for example, a known weight scale can be used.

The defective product detection unit of the work determination apparatus detects whether or not the work to be determined is a defective product on the basis of the weight measured by the weight measurement unit. For example, the defective product detection unit may detect a defective work on the basis of the weight of a non-defective work stored in advance in the work determination apparatus, and the weight measured by the weight measurement unit. In this case, the defective product detection unit may compare the weight of the non-defective product with the weight measured by the weight measurement unit, and decide that the work is a defective product in a case where a difference in the weight is larger than or equal to a predetermined value.

The work determination system of the present embodiment can automate the work of detecting a defective product by including the weight measurement unit and the defective product detection unit.

Note that the rolling force transmission unit of the second embodiment may be combined with the third embodiment.

### Example

Hereinafter, the present technology will be described in more detail on the basis of examples. Note that the examples described below each illustrate an example of a typical example of the present technology, and the present technology is not limited to the following examples.

A test of determining a work was conducted using the work determination system of the present technology. As the work, an AC cable for a specific destination (country A) was used. The work determination system was caused to determine the AC cable with a correct answer being a case where the destination of the AC cable was determined to be country A, and an incorrect answer being a case where the destination of the AC cable was determined to be other than country A.

The polarized camera, ring light, and image generation software used in the work determination system are as follows.

The image generation software was installed and used on a computer that is the work determination apparatus. Moreover, when the AC cable was imaged with the polarized camera, the AC cable was placed on a black flat sheet having a lower light reflectance than the AC cable.

Polarized camera: “XCG-CG510” manufactured by Sony Corporation

Ring light: “IPS-R150MA-W-IF20” manufactured by IP_System Corporation

Image generation software: software manufactured by Sony Global Manufacturing & Operations Corporation

### First Example

A reference image of the AC cable was acquired using the work determination apparatus, and worked images (reflection-removed image, degree-of-polarization image, and normal-direction image) were generated from the reference image. These images were used to construct a determination model according to the processing illustrated in FIG. 8. Next, a reference image and worked images (reflection-removed image, degree-of-polarization image, and normal-direction image) of an AC cable to be determined were acquired, and a test was conducted to determine the AC cable by the work determination apparatus using these images and the determination model. The test was conducted in the following four patterns by changing the number of images used for machine learning and determination.

[Images Used for Machine Learning and Determination]

First test: reference image (only one image)

Second test: reference image and one of worked images (two images in total)

Third test: reference image and two of worked images (three images in total)

Fourth test: reference image and three worked images (four images in total)

FIG. 11 illustrates an example of the images used in the first to fourth tests. FIG. 11A is a reference image, FIG. 11B is a reflection-removed image, FIG. 11C is a degree-of-polarization image, and FIG. 11D is a normal-direction image. The first to fourth tests were each conducted multiple times, and the accuracy rates were calculated. The accuracy rates for the first to fourth tests are illustrated below.

[Accuracy Rates]

First test: 90.25%

Second test: 98.08%

Third test: 98.83%

Fourth test: 98.91%

From these results, it was confirmed that the work can be automatically and highly accurately determined by using the work determination system of the present technology. It was also confirmed that the more types of images used for machine learning and determination, the better the determination accuracy.

### Second Example

Fifth to seventh tests for determining the AC cable were conducted. The fifth test was conducted in a manner similar to that of the fourth test in the first example except that the sheet placed under the work was changed to a black sheet that is bent as illustrated in FIG. 10. The sixth test was conducted in a manner similar to that of the fifth test except that the color of the sheet placed under the work was changed from black to white. The seventh test was conducted in a manner similar to that of the fifth test except that the color of the sheet placed under the work was changed from black to green. The black sheet had the lowest light reflectance.

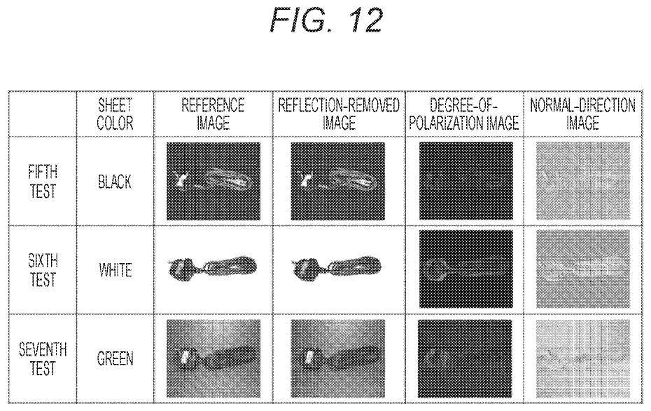

FIG. 12 illustrates an example of images used in the fifth to seventh tests. As illustrated in FIG. 12, it was confirmed that a characteristic part of the AC cable looked different depending on the color of the sheet.

As a result of conducting the fifth to seventh tests, the accuracy rate of the work determination system was the highest in the fifth test, followed by the sixth test, and the lowest in the seventh test. From these results, it was confirmed that the work determination accuracy is further improved by placing the work on the sheet having the low light reflectance.

Note that the present technology can also be embodied in the following configurations.

[1] A work determination system including a polarized camera that images a work and a work determination apparatus, in which

the work determination apparatus includes:

a reference image acquisition unit that acquires a reference image of the work imaged by the polarized camera;

a determination model construction unit that constructs a determination model for determining the work by machine learning using the reference image; and

a determination unit that determines a work to be determined by using the reference image of the work to be determined and the determination model constructed in advance.

[2] The work determination system according to [1], in which the work determination apparatus includes a worked image generation unit that generates a worked image on the basis of the reference image,

the determination model construction unit further uses the worked image in the machine learning, and

the determination unit further uses the worked image at the time of determining the work to be determined.

[3] The work determination system according to [2], in which the worked image is at least one type of image selected from a reflection-removed image, a degree-of-polarization image, or a normal-direction image.
[4] The work determination system according to any one of [1] to [3], in which the determination model construction unit further uses information on a destination of the work in the machine learning, and

the determination unit determines whether or not the work to be determined is a work corresponding to a predetermined destination.

[5] The work determination system according to any one of [1] to [4], further including a ring-shaped light source that irradiates the work imaged by the polarized camera with light.
[6] The work determination system according to any one of [1] to [5], in which the work imaged by the polarized camera is placed on a sheet, and

a light reflectance of the sheet is lower than a light reflectance of the work.

[7] The work determination system according to any one of [1] to [6], further including a rolling force transmission unit that rolls the work imaged by the polarized camera.
[8] The work determination system according to any one of [1] to [7], further including a weight measurement unit that measures weight of the work to be determined, in which

the work determination apparatus includes a defective product detection unit that detects a defective work on the basis of the weight measured by the weight measurement unit.

[9] A work determination apparatus including:

a reference image acquisition unit that acquires a reference image of a work imaged by a polarized camera;

a determination model construction unit that constructs a determination model for determining the work by machine learning using the reference image; and

a determination unit that determines a work to be determined by using the reference image of the work to be determined and the determination model constructed in advance.

[10] A work determination method including:

a step of acquiring a reference image of a work imaged by a polarized camera;

a step of constructing a determination model for determining the work by machine learning using the reference image; and

a step of determining a work to be determined by using the reference image of the work to be determined and the determination model constructed in advance.

### REFERENCE SIGNS LIST

1 Work determination system
10 Polarized camera
11 Lens
20 Work determination apparatus
30 Ring-shaped light source
40, 40A Sheet
50 Fixing member

1. A work determination system comprising a polarized camera that images a work and a work determination apparatus, wherein
the work determination apparatus comprises:
a reference image acquisition unit that acquires a reference image of the work imaged by the polarized camera;
a determination model construction unit that constructs a determination model for determining the work by machine learning using the reference image; and
a determination unit that determines a work to be determined by using the reference image of the work to be determined and the determination model constructed in advance.

2. The work determination system according to claim 1, wherein the work determination apparatus comprises a worked image generation unit that generates a worked image on a basis of the reference image,
the determination model construction unit further uses the worked image in the machine learning, and
the determination unit further uses the worked image at the time of determining the work to be determined.

3. The work determination system according to claim 2, wherein the worked image is at least one type of image selected from a reflection-removed image, a degree-of-polarization image, or a normal-direction image.

4. The work determination system according to claim 1, wherein the determination model construction unit further uses information on a destination of the work in the machine learning, and
the determination unit determines whether or not the work to be determined is a work corresponding to a predetermined destination.

5. The work determination system according to claim 1, further comprising a ring-shaped light source that irradiates the work imaged by the polarized camera with light.

6. The work determination system according to claim 1, wherein the work imaged by the polarized camera is placed on a sheet, and
a light reflectance of the sheet is lower than a light reflectance of the work.

7. The work determination system according to claim 1, further comprising a rolling force transmission unit that rolls the work imaged by the polarized camera.

8. The work determination system according to claim 1, further comprising a weight measurement unit that measures weight of the work to be determined, wherein
the work determination apparatus comprises a defective product detection unit that detects a defective work on a basis of the weight measured by the weight measurement unit.

9. A work determination apparatus comprising:
a reference image acquisition unit that acquires a reference image of a work imaged by a polarized camera;
a determination model construction unit that constructs a determination model for determining the work by machine learning using the reference image; and
a determination unit that determines a work to be determined by using the reference image of the work to be determined and the determination model constructed in advance.

10. A work determination method comprising:
a step of acquiring a reference image of a work imaged by a polarized camera;
a step of constructing a determination model for determining the work by machine learning using the reference image; and
a step of determining a work to be determined by using the reference image of the work to be determined and the determination model constructed in advance.
